(19) United States
(12) Patent Application Publication
(10) Pub. No.: US 2026/0125001 A1
(43) Pub. Date: May 7, 2026

(54) Sealing Element for a Motor Vehicle and Arrangement

(71) Applicant: Bayerische Motoren Werke Aktiengesellschaft, Muenchen (DE)

(72) Inventors: Oeztzan AKIF, Muenchen (DE); Cansu Kirdar-Eckstein, Muenchen (DE); Haci Korkusuz Janket, Putzbrunn (DE); Stefan Maehlmann, Muenchen (DE)

(21) Appl. No.: 19/378,452

(22) Filed: Nov. 4, 2025

(30) Foreign Application Priority Data
Nov. 5, 2024 (DE) 10 2024 132 135.0

(51) Int. Cl. B60R 13/06

(52) U.S. Cl. CPC B60R 13/06

(57) ABSTRACT

A sealing element for a motor vehicle has at least one first bearing region via which the sealing element can be arranged on a front flap of the motor vehicle, which is pivotable between a closed position and at least one open position, and at least one second bearing region via which the sealing element can be arranged at least indirectly on a structural element of the motor vehicle which is configured separately from the front flap. In the closed position, the front flap can be supported at least indirectly on the structural element via the sealing element by way of the bearing regions. A folded edge of the front flap, which is arranged at a front end of the front flap in the vehicle longitudinal direction, can be surrounded at least in some regions by the first bearing region.

### CROSS REFERENCE TO RELATED APPLICATION

This application claims priority under 35 U.S.C. § 119 from German Patent Application No. DE 10 2024 132 135.0, filed Nov. 5, 2024, the entire disclosure of which is herein expressly incorporated by reference.

### BACKGROUND AND SUMMARY

The invention relates to a sealing element for a motor vehicle. The invention further relates to an arrangement of a sealing element on a front region of a motor vehicle.

DE 11 2017 006 736 T5 discloses a motor vehicle comprising a vehicle body, an engine compartment which receives an engine, and an engine hood which is movably coupled to the vehicle body and is arranged in order to provide a closure element for the engine compartment, wherein the engine hood is movable between open and closed states.

It is the object of the invention to provide a sealing element for a motor vehicle and an arrangement of a sealing element on a front region of a motor vehicle so that a comfort of the motor vehicle can be particularly increased.

This object is achieved according to the invention by a sealing element for a motor vehicle and by an arrangement of a sealing element on a front region of a motor vehicle having the features of the independent claims. Advantageous embodiments of the invention form the subject matter of the dependent claims and the description.

A first aspect of the invention relates to a sealing element for a motor vehicle, in particular for a front flap of the motor vehicle. The sealing element can thus be denoted as the front flap seal. The motor vehicle is configured, for example, as a passenger motor vehicle. Preferably, the motor vehicle has the sealing element, in particular in its fully manufactured state.

The sealing element being provided or being configured for the front flap of the motor vehicle can be understood to mean, in particular, that the sealing element is provided or configured for arranging on the front flap. Thus the sealing element can be arranged or is arranged, in particular, on the front flap.

The sealing element has at least one first bearing region which can be understood to mean, in particular, a first sealing region of the sealing element. The sealing element can be arranged or is arranged via the first bearing region, for example at least indirectly or directly, on a front flap of the motor vehicle, which is pivotable between a closed position and at least one open position, for example about at least one pivot axis, whereby the sealing element bears, in particular directly, against the front flap via the first bearing region, for example at least in the closed position of the front flap. In other words, the bearing region is configured or provided to be arranged, in particular to be placed, against the front flap, in particular at least in the closed position.

For example, the front flap can be held or is held, in particular at least indirectly or directly, on a body of the motor vehicle, i.e. for example on at least one body component of the body or of the motor vehicle, so as to be pivotable at least between the closed position or at least one open position. Pivoting the front flap between the closed position and the open position can be understood to mean, in particular, a pivoting of the front flap from the closed position into the open position and/or from the open position into the closed position. Moreover, pivoting the front flap can be understood to mean, in particular, a pivoting of the front flap relative to the body, for example to the body component.

The front flap can be understood to mean, in particular, a front hood which can be denoted as the engine hood. The front flap is provided or configured, for example, for covering, in particular for closing, at least one front-side receiving space of the motor vehicle. Preferably, in the closed position the front-side receiving space, in particular at least one opening leading into the front-side receiving space, can be closed or is closed by means of the front flap. In other words, in the closed position the front-side receiving space, in particular the opening, can be covered or is covered, for example, upwardly at least in the vehicle vertical direction of the motor vehicle. Preferably, in the open position the receiving space, in particular the opening, is at least partially, in particular substantially or fully, opened up by the front flap. In other words, the closure or the covering of the receiving space, in particular the opening, is prevented in the open position. The front-side receiving space is, for example, an engine compartment. Alternatively, the front-side receiving space can be denoted, for example, as a front-side storage compartment which can also be denoted as a “frunk”.

The sealing element also has at least one second bearing region which is, in particular, different from the first bearing region, which can be understood to mean, in particular, a second sealing region of the sealing element. The sealing element can be arranged or is arranged via the second bearing region at least indirectly, in particular directly, on at least one structural element of the motor vehicle which is configured separately from the front flap, whereby in particular at least in the closed position the sealing element bears via the second bearing region at least indirectly, in particular directly, against the structural element. In other words, the second bearing region of the sealing element is configured to be arranged, in particular to be at least indirectly placed, against the structural element or onto the structural element. In particular, by arranging the sealing element on the front flap and the structural element via the respective bearing region, for example in the closed position, the front-side receiving space can be sealed or is sealed by the sealing element at least in some regions relative to an environment of the motor vehicle. For example, the first bearing region can be arranged or is arranged in the closed position and in the open position, in particular directly, on the front flap, and the second bearing region can be arranged or is arranged, for example, relative to the open position and the closed position exclusively in the closed position at least indirectly, in particular directly, on the structural element. Alternatively, for example, the second bearing region can be arranged or is arranged in the closed position and in the open position at least indirectly on the structural element, and the first bearing region can be arranged or is arranged relative to the open position and the closed position exclusively in the closed position on the front flap.

Moreover, it is provided that, in particular for sealing a gap extending between the front flap and the structural element, in particular at least in some regions, in particular in the closed position, the front flap can be supported or is supported in the closed position on the structural element via the sealing element by means of the bearing regions, in particular at least indirectly or directly, for example downwardly at least in the vehicle vertical direction of the motor vehicle. In other words, since the first bearing region is arranged in the closed position on the front flap and the second bearing region is arranged in the closed position at least indirectly on the structural element, the front flap can be supported or is supported in the closed position on the structural element via the sealing element by means of the bearing regions, at least indirectly, in particular directly. This means that the front flap and the structural element can be bridged or are bridged at least in some regions by means of the sealing element.

In order to be able to increase particularly a comfort of the motor vehicle, in particular in order to be able to improve particularly an acoustic behavior of the motor vehicle, it is provided according to the invention that a folded edge of the front flap, which is arranged or configured at a front end of the front flap in the vehicle longitudinal direction of the motor vehicle, can be surrounded or is surrounded at least in some regions, in particular at least substantially, by the first bearing region, in particular directly, and namely preferably at least in the closed position, in particular in the closed position and in the open position. This means, for example, that the first bearing region, in particular in the installed position of the sealing element in or on the motor vehicle, extends at least on two, in particular different, sides of the folded edge, whereby for example the first bearing region at least in some regions surrounds the folded edge at least on these sides. In other words, the sealing element can be arranged or is arranged via the bearing region so as to surround the folded edge of the front flap at least in some regions, in particular substantially. Once again in other words, the first bearing region is configured to surround the folded edge of the front flap at least in some regions.

The folded edge can be understood to mean, in particular, a bent or folded part of the front flap. Thus the folded edge is or is to be formed, for example, by bending or folding, in particular flanging, an outer geometry of the front flap. The folded edge is thus, in particular, a folded edge which is formed or manufactured by means of flanging.

The invention is based, in particular, on the following recognitions and considerations: stepless or minimal step transitions between an outer skin in or on a front of the motor vehicle and the front flap can provide a very precise and neat or clean impression in terms of shape in a vehicle design. Thus a particularly high value can be placed thereon in the external design. This is because in the known prior art, for example, a fender cover, a decorative grille or a headlight can be designed in the transition to the front flap, for example, such that a joint is formed which as far as possible does not disrupt the stepless or minimal step transition which, in particular, is a flush transition. As a result, however, a transition from a laminar into a turbulent flow can be produced on the folded edge, in particular on a flanged edge, of the front flap, whereby for example acoustic noise can occur even at low speeds. The flow can be understood to mean, in particular, an airflow which flows onto the motor vehicle when the motor vehicle is traveling. This airflow can be denoted as driving wind.

Accordingly, the aforementioned drawbacks can be remedied by means of the sealing element according to the invention. The sealing element, which can also be simply denoted as the seal, is or is to be attached to the front flap, for example, such that the sealing element closes the aforementioned joint in the vehicle longitudinal direction particularly far to the front, in particular to a maximum extent to the front, and in particular at the same time, for example, surrounds the folded edge of the front flap which is configured as a flanged edge by means of at least one contour which is formed, in particular, by the first bearing region. By the folded edge being surrounded by the first bearing region, therefore, the flow behavior of the airflow can be particularly improved when the motor vehicle is traveling and namely, in particular, such that the transition from the laminar into the turbulent flow can be avoided or kept particularly small. As a result, the noise can be avoided or kept particularly low, whereby the acoustic behavior of the motor vehicle can be particularly improved. As a result, the comfort of the motor vehicle, in particular an acoustic comfort of the motor vehicle, can be particularly improved. Moreover, the sealing element can be centered on or via the folded edge of the front flap by means of the first bearing region, whereby the sealing element can be placed, in particular for centering, for example in a defined manner, against the front flap, in particular the folded edge. As a result, the installed position of the sealing element can be ensured particularly precisely, in particular in a particularly careful manner, which can also have a positive effect on the acoustic behavior. Moreover, a manufacturing quality of the motor vehicle can be particularly enhanced and/or a manufacturing effort of the motor vehicle kept particularly low.

In a further embodiment, it is provided that the second bearing region, in particular in the installed position of the sealing element on or in the motor vehicle in the vehicle vertical direction, is arranged further below than the first bearing region, in particular at least in some regions, for example substantially or entirely. In other words, the second bearing region extends at least in some regions further downwardly in the vehicle vertical direction than the first bearing region, whereby the sealing element bridges the front flap and the structural element, for example starting from the front flap downwardly in the vehicle vertical direction, in particular as far as the structural element. As a result, the airflow can be positively influenced, in particular by a resulting shape of the sealing element, whereby the aforementioned transition into the turbulent flow can be maintained or can be kept particularly small.

In a further embodiment, it is provided that the first bearing region has two partial regions extending obliquely or perpendicularly to one another. In other words, the partial regions of the first bearing region run obliquely or perpendicularly to one another. For example, the partial regions adjoin one another, in particular protruding obliquely or perpendicularly from one another, for example at least indirectly, in particular directly. The first bearing region can surround the folded edge, in particular the flanged edge, in a particularly well-defined manner at least in some regions by the partial regions extending obliquely or perpendicularly to one another, whereby the airflow can be positively influenced in order to improve particularly the acoustic behavior or the comfort of the motor vehicle.

In a further embodiment, it is provided that via a first of the partial regions the sealing element can be arranged or is arranged on an inner face of the folded edge, in particular in the closed position facing the front-side receiving space, in particular directly on the folded edge, for example on at least one folded edge surface of the folded edge, whereby the first partial region, for example, in particular bears directly against the folded edge, in particular against the folded edge surface. In other words, the first partial region extends to or on the inner face of the folded edge. The inner face of the folded edge can be understood to mean, in particular, a side of the folded edge facing away from an environment of the motor vehicle in the closed position. Moreover, the aforementioned folded edge surface of the folded edge can be understood to mean, in particular, a surface facing toward the front-side receiving space and/or a surface facing away from the environment at least in the closed position. The sealing element can be arranged or is arranged via the second partial region, in particular directly, on a folded edge rim, in particular a flanged edge, of the folded edge, whereby the second partial region bears, for example, in particular directly, against the flanged edge. In other words, the second partial region of the first bearing region extends, in particular directly, on the folded edge rim or flanged edge of the folded edge. As a result, the sealing element can be placed via the first bearing region in a particularly defined manner against the folded edge, whereby the folded edge can be surrounded particularly effectively, in particular particularly extensively, by the first bearing region. As a result, the acoustic behavior can be particularly improved. Moreover, the aforementioned centering can be particularly improved. The inner face of the folded edge, in particular the aforementioned folded edge surface, faces downwardly in the vehicle vertical direction of the motor vehicle and/or to the rear in the vehicle longitudinal direction of the motor vehicle, for example. The folded edge rim faces to the front in the vehicle longitudinal direction of the motor vehicle and/or downwardly in the vehicle vertical direction of the motor vehicle, for example. The folded edge rim has, for example, a radius which can be denoted as a folded edge radius or bending radius. The folded edge rim can thus be denoted as the folded edge radius. Before forming the folded edge, the aforementioned folded edge surface, for example, faces outwardly, whereby, before forming the folded edge, the folded edge surface is a surface of the initial geometry of the front flap facing the environment, for example, in particular in the closed position.

In order to be able to fix the sealing element particularly securely, in a further embodiment it is provided that the sealing element has at least one fastening surface formed, for example, by the first bearing region, in particular the first partial region, for fastening, for example directly, to the front flap. This means that the sealing element can be fastened or is fastened to the front flap via the fastening surface, in particular at least indirectly or directly, and in particular both in the closed position and in the open position. For example, the sealing element can be arranged or is arranged on the front flap both in the open position and in the closed position via the first bearing region, in particular via the partial regions. For example, the first bearing region, in particular the first partial region, has the fastening surface.

In order to be able to fix the sealing element particularly securely to the front flap, in a further embodiment it is provided that the fastening surface is an adhesive surface for fastening the sealing element to the front flap by means of adhesive bonding. In other words, the sealing element can be adhesively bonded to the front flap or is adhesively bonded to the front flap via the fastening surface or via the adhesive surface.

In a further embodiment, it is provided that the sealing element can be arranged or is arranged via the second bearing region at least indirectly, in particular directly, or by means of at least one hard component, on a component of a headlight as the structural element. In other words, the structural element is configured as the component of the headlight. As a result, the receiving space can be held in a particularly sealed manner and at the same time the aforementioned joint closed particularly advantageously, in particular particularly advantageously in terms of flow, whereby the noise can be kept particularly low or can be avoided. The component of the headlight is, for example, a lens of the headlight. The lens is configured, in particular, for the passage of light generated by means of the headlight. This means that, for example, the light generated by at least one lighting means of the headlight can pass via the lens into the environment of the motor vehicle, in particular to illuminate the environment. The lens is formed, for example, from plastics and/or from glass.

In a further embodiment, it is provided that the sealing element has at least one support region, in particular facing away from the first and/or the second partial region of the first bearing region, the sealing element being able to be supported or is supported thereby on at least one hard component which is arranged, for example, at least indirectly or directly on the front flap and which can be denoted as the second hard component and is configured, in particular, separately from the sealing element. In other words, the sealing element bears, in particular at least indirectly or directly, via the support region against the second hard component. As a result, a centering action can be achieved for the sealing element, whereby the sealing element can be centered via the support region, in particular for arranging or fastening on the front flap, by means of the second hard component or on the hard component, for example in addition to the folded edge. The centering can thus take place, for example, via the folded edge and via the support region on the second hard component. In order to be able to implement a particularly accurate alignment of the sealing element in the vehicle, the second hard component is or is to be represented, for example, with an alignment concept. Due to the centering on or by means of the hard component, the production quality of the motor vehicle can be particularly increased and/or the manufacturing effort of the motor vehicle kept particularly low. The support of the sealing element via the support region on the second hard component is implemented, for example, via at least one rib of the second hard component, wherein this rib can be denoted as the alignment rib. The at least one rib, for example, protrudes, in particular obliquely or perpendicularly, from a base body of the second hard component. The second hard component has, for example, a greater stiffness and/or a greater strength than the sealing element. This means that the second hard component is formed from a harder and/or less resilient and/or less flexible material than the sealing element.

In order to be able to seal the front-side receiving space particularly effectively by means of the sealing element, in a further embodiment the bearing regions, i.e. the first and the second bearing region, are connected together at least indirectly, in particular directly, via at least one predetermined bending point. In other words, the sealing element has the predetermined bending point, via which the bearing regions are coupled together at least indirectly, in particular directly. It is provided that when pivoting the front flap, in particular from the open position, into the closed position by at least indirect, for example direct, in particular mechanical, action on the sealing element by the structural element, for example by means of the hard component, the bearing regions can be pivotable or are pivoted relative to one another by, in particular, at least elastic deformation of the sealing element. In other words, the pivoting of the front flap, in particular from the open position, into the closed position is associated with the pivoting of the bearing regions, in particular around the predetermined bending point, whereby for example the, in particular at least indirect, arrangement of the second bearing region on the structural element can be brought about or is brought about, for example, by means of the hard component. This means, for example, that the sealing element in the open position of the front flap has a first shape and in the closed position of the front flap has a second shape which is different from the first shape, wherein with the second shape the bearing regions are pivoted relative to one another, in particular on the or about the predetermined bending point, relative to the first shape, wherein a change in shape from the first shape to the second shape results from, in particular, an elastic deformation of the sealing element, in particular by means of the predetermined bending point, and wherein a force to be applied for bringing about this deformation can be introduced or is introduced, in particular at least indirectly, by the structural element, for example by means of the hard component, into the sealing element, in particular into the second bearing region. The respective shape can be understood to mean a respective geometry. The predetermined bending point thus forms, in particular, a predetermined bending axis which can also be denoted as the second pivot axis. As a result, it can be ensured in a particularly careful manner that in the closed position the sealing element bears against the structural element via the second bearing region, for example by means of the hard component. Moreover, due to the aforementioned deformation a restoring force can be brought about, the sealing element pressing thereby onto the structural element, in particular via the second bearing region, for example by means of the hard component, whereby the sealing action can be particularly improved by means of the sealing element.

A second aspect of the invention relates to an arrangement of a sealing element, in particular according to the first aspect of the invention, on or in a front region of a motor vehicle. The front region can be understood to mean, in particular, a front end region in the vehicle longitudinal direction which can also be denoted simply as the front or vehicle front of the motor vehicle. Advantages and advantageous embodiments of the first aspect of the invention can be regarded as advantages and advantageous embodiments of the second aspect of the invention and vice versa. Moreover, the arrangement can be understood to mean, in particular, an arrangement of the sealing element on a front flap of the motor vehicle.

The sealing element is arranged via at least one first bearing region of the sealing element on a front flap of the motor vehicle, which is pivotable between a closed position and at least one open position, in particular at least indirectly or directly, at least in the closed position, in particular in the closed position and in the open position. Moreover, the sealing element is arranged via at least one second bearing region of the sealing element at least in the closed position at least indirectly, in particular directly, on at least one structural element of the motor vehicle which is configured separately from the front flap, wherein, in particular whereby, for example for sealing a gap extending between the front flap and the structural element, at least in some regions, in the closed position the front flap is supported, in particular indirectly or directly, on the structural element via the sealing element by means of the bearing regions, for example downwardly at least in the vehicle vertical direction.

In order to be able to improve particularly a comfort of the motor vehicle, in particular an acoustic behavior of the motor vehicle, it is provided according to the invention that the first bearing region surrounds, at least in some regions, in particular at least substantially, a folded edge of the front flap, in particular a folded edge rim or a folded edge radius of the folded edge, which is arranged or configured at a front end of the front flap in the vehicle longitudinal direction.

A further aspect relates to a method for manufacturing a motor vehicle and/or for arranging a sealing element, in particular according to the first aspect of the invention, on the front flap. Advantages and advantageous embodiments of the first or second aspect of the invention are to be regarded as advantages and advantageous embodiments of the further aspect and vice versa. Also disclosed is a motor vehicle which has at least one sealing element according to the first aspect of the invention and/or at least one arrangement according to the second aspect of the invention.

Further features of the invention are found in the claims, the figures and the description of the figures. The features and combinations of features mentioned above in the description and the features and combinations of features mentioned below in the description of the figures and/or shown individually in the figures are not only able to be used in the respectively specified combination but also in other combinations or individually.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic and perspective partial view of an arrangement according to an embodiment of the invention; and

FIG. 2 is a schematic partial sectional view of an arrangement according to the embodiment of the invention.

Elements which are the same or functionally the same are provided with the same reference signs in the figures.

### DETAILED DESCRIPTION OF THE DRAWINGS

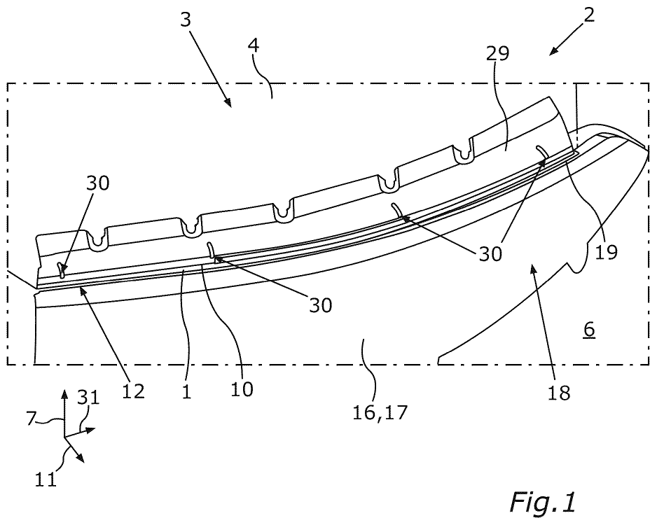

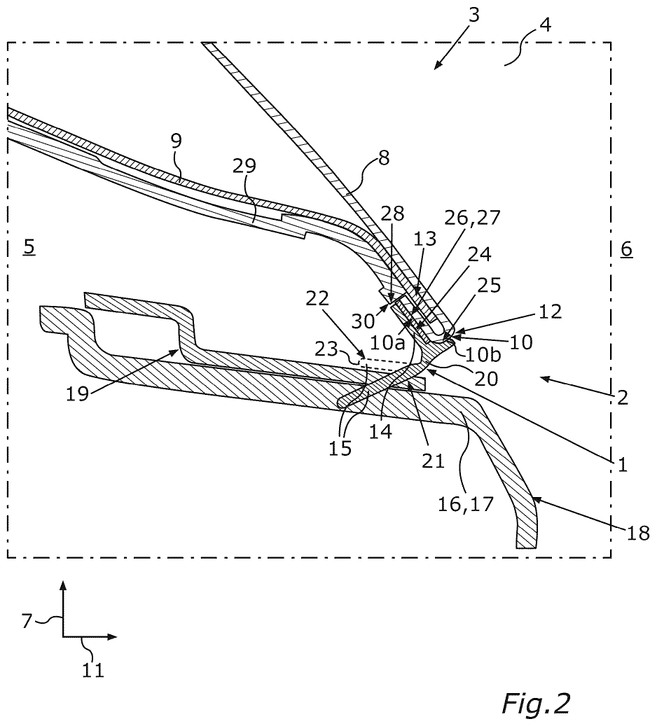

FIG. 1 shows in a schematic and perspective partial view an arrangement of a sealing element 1 on a front region 2 of a motor vehicle. Thus in FIG. 1 the motor vehicle is shown, in particular, in a detail. In FIG. 2 the arrangement is shown in a schematic partial sectional view.

The motor vehicle has a front flap 4 which is pivotable between a closed position 3 and at least one open position, for example about at least one pivot axis. In FIG. 1 and FIG. 2 the front flap 4 is in the closed position 3. At least one front-side receiving space 5 of the motor vehicle preferably can be covered or is covered, for example at least substantially, in particular fully, by means of the front flap 4, in particular relative to the open position and the closed position, exclusively in the closed position 3. The front-side receiving space 5 is thus located, in particular in the closed position 3, to the rear relative to an environment 6 of the motor vehicle, for example in the vehicle vertical direction 7 below the front flap 4. The front-side receiving space 5 is configured, for example, as an engine compartment or as a front-side storage compartment.

The front flap 4 is configured, for example, in multiple parts, in particular two parts. Thus the front flap has at least one first front flap part 8 and at least one second front flap part 9 which is fastened, in particular, to the first front flap part 8. The front flap parts 8, 9 are configured, for example, separately from one another. The first front flap part 8 is configured, for example, as the outer part. The second front flap part 9 is configured, for example, as the inner part. Thus, for example, the second front flap part 9 is covered outwardly by the first front flap part 8 at least in some regions, in particular relative to the environment 6.

Moreover, the front flap 4, in particular the first front flap part 8, has a folded edge 10 which is arranged or configured on a front-side or front end 12 of the front flap 4, in particular of the first front flap part 8 in the vehicle longitudinal direction 11. The folded edge 10 is or is to be manufactured preferably by flanging, whereby the folded edge 10, for example, has a flanged edge which is formed, in particular, by a radius and which can also be denoted as a flange radius. The flanged edge is thus, in particular, a rounded-off or rounded edge which thus, in particular, is not formed with corners.

In the exemplary embodiment shown according to FIG. 2, the second front flap part 9 is arranged or received in some regions in the folded edge 10. This means that the folded edge 10 defines at least one receiving region 13 at least partially, in particular at least substantially, in which the second front flap part 9 is arranged or received in some regions. The first front flap part 8 is thus bent in some regions about the second front flap part 9, for example, in particular in the region of the folded edge 10 or by the folded edge.

As can be particularly clearly identified in FIG. 2, the sealing element 1 has at least one first bearing region 14 via which the sealing element 1, in particular at least in the closed position 3, preferably in the closed position 3 and in the open position of the front flap 4, is arranged on the front flap 4, for example on the first front flap part 8, so that for example the sealing element 1 bears via the first bearing region 14, in particular directly, against the front flap 4, for example the first front flap part 8 in order to seal, for example, the front flap 4 relative to the environment 6. The first bearing region 14 is configured, for example, as a sealing lip.

Moreover, the sealing element 1 has at least one second bearing region 15, which is, in particular, different from the first bearing region 14 and which preferably is spaced apart from the first bearing region 14. The sealing element 1 is arranged or can be arranged via the second bearing region 15 at least in the closed position 3, for example relative to the closed position 3 and the open position exclusively in the closed position 3, at least indirectly on a structural element 16 of the motor vehicle which is configured separately from the front flap 4. The sealing element 1 is configured separately from the front flap 4 and separately from the structural element 16. In the closed position 3, in particular relative to the closed position 3 and the open position exclusively in the closed position, the front flap 4 is at least indirectly supported on the structural element 16, for example downwardly at least in the vehicle vertical direction 7, via the sealing element 1 by means of the bearing regions 14, 15. Thus in the closed position 3, for example, a gap extending at least in some regions, in particular in the vehicle vertical direction 7, between the front flap 4, for example the first front flap part 8, and the structural element 16, is closed by means of the sealing element 1 or bridged by the sealing element 1. The second bearing region 15 is configured, for example, as a sealing lip.

The structural element 16 is configured, for example, as a component 17 of a headlight 18 of the motor vehicle, whereby the sealing element 1 can be arranged or is arranged, in particular via the second bearing region 15, at least indirectly on the component 17 and/or the front flap 4 is supported in the closed position 3 at least indirectly on the component 17 via the sealing element 1 by means of the bearing regions 14, 15. The component 17 is configured, for example, as a lens of the headlight 18. The lens is formed from a plastics, in particular from polycarbonate, for example at least in some regions, in particular substantially or fully.

In the exemplary embodiment shown in FIG. 1 and FIG. 2, the arrangement of the sealing element 1 via the second bearing region 15 and/or the support of the sealing element 1 via the second bearing region 15 on the structural element 16 takes place via at least one hard component 19, i.e. by means of the hard component 19 which for example is arranged or in particular fastened, in particular at least indirectly or directly, on the structural element 16 and namely preferably on a side of the structural element 16 facing upwardly in the vehicle vertical direction 7. The hard component 19 thus extends, for example, in particular in the vehicle vertical direction 7 between the sealing element 1 and the structural element 16 and namely, in particular, when the front flap 4 is in the closed position 3. The hard component 19 serves, for example, as a support surface for the sealing element 1 so that the sealing element 1 does not bear, for example, directly against the structural element 16 but, in particular, can be supported or is supported on the structural element 16 by means of the hard component 19. A stiffness of the hard component 19 is, for example, greater than a stiffness of the sealing element 1. Alternatively or additionally, for example, the sealing element 1 is configured to be more elastic or more flexible, in particular softer, than the hard component 19. The hard component 19 can also be denoted as the first hard component 19.

Moreover, in the exemplary embodiment shown in FIG. 1 and FIG. 2, the sealing element 1 has at least one predetermined bending point 20 via which the bearing regions 14, 15 are connected together at least indirectly, in particular directly. Preferably, when pivoting the front flap 4, in particular, from the open position into the closed position 3 the bearing regions 14, 15 can be pivoted or bent relative to one another by at least indirect action on the sealing element 1 by the structural element 16, in particular by means of the hard component 19, by the deformation of the sealing element 1 at least in some regions, i.e. by deforming the sealing element 1 at least in some regions, for example about at least one bending axis running through the predetermined bending point 20. The bending axis can also be denoted as the second pivot axis. The pivoting about the bending axis or the deformation of the sealing element 1, in particular, is a targeted pivoting or a targeted deformation. This is implemented, for example, by the sealing element 1 having at least one material weakening in the region of the predetermined bending point 20, in particular at the predetermined bending point 20. In other words, the predetermined bending point 20 is configured as a material weakening, in particular a local material weakening, of the sealing element 1. Thus the predetermined bending point 20, for example, is thinned out. In the present case, the pivoting of the bearing regions 14, 15 is a pivoting of the bearing regions 14, 15 relative to one another from a first position 21 into a second position 22 which is different from the first position 21. In the first position 21, the sealing element 1 has, for example, a first shape and in the second position 22 the sealing element has, for example, a second shape which is different from the first shape. In FIG. 2 the sealing element 1 is shown in the first position 21. The second position 22 in FIG. 2, however, in particular is additionally illustrated by means of dashed lines 23. Thus in the present case the sealing element 1 is in the first position 21 when the front flap 4 is in the open position. Moreover, in the present case the sealing element 1 is in the second position 22 when the front flap 4 is in the closed position 3. Thus, for example in the second position 22, the sealing element 1 bears, in particular directly, against the hard component 19, whereby in particular the sealing element 1 is arranged on the structural element 16 in the second position 22 via the second bearing region 15 by means of the hard component 19.

In order to be able to improve particularly a comfort of the motor vehicle, in particular an acoustic behavior of the motor vehicle, at least the first bearing region 14 of the sealing element 1 surrounds the folded edge 10, in particular the flanged edge, at least in some regions. Thus the sealing element 1 or the first bearing region 14, for example, extends in the vehicle longitudinal direction 11 to the front around the flanged edge of the front flap 4, wherein the sealing element 1, in particular, bears against the front flap 4 and, for example, against the structural element 16. As a result, when the motor vehicle is traveling, an airflow flowing onto the structural element and/or the front flap 4 can be influenced by means of the sealing element 1, in particular in a targeted manner, whereby for example a transition from a laminar flow of the airflow into a turbulent flow of the airflow can be avoided or can be kept particularly small. Thus a turbulence of the airflow in the region of the sealing element 1, in particular in the region of the sealing element 1 and the front flap 4, for example, is particularly small, and namely in particular smaller if the sealing element 1 were not to extend around the flanged edge. This has the result that noise, in particular caused by driving wind, can be kept particularly low. The sealing element 1 is accordingly, in particular, a front flap seal with a sound-damping function.

Preferably, the first bearing region 14 has two partial regions 24, 25 extending obliquely or perpendicularly to one another. A first of the partial regions 24 bears, for example, against a first sealing surface of the front flap 4, for example of the first front flap part 8, in particular of the folded edge 10. The second of the partial regions 25 bears, for example, against a second sealing surface of the front flap 4, in particular of the first front flap part 8, for example of the folded edge 10. The first bearing region 14 is accordingly configured, in particular, corresponding to the front flap 4, preferably corresponding to the folded edge 10. The partial regions 24, 25 protrude from one another, for example, in particular obliquely or perpendicularly relative to one another. For example, the second partial region 25 protrudes at least as far from the first partial region 24 as a spacing which extends between the first partial region 24 and a bending axis of the folded edge 10. The bending axis can be understood to mean, in particular, an axis about which the front flap 8 can be bent or is bent or has been bent to form the folded edge 10. For example, the second partial region 25 is configured as a sealing nose, in particular a sealing nose around the flanged edge.

For example, the sealing element 1 can be arranged or is arranged via the first partial region 24 on the folded edge 10, on an inner face 10a of the folded edge 10, for example an aforementioned first sealing region. The sealing element 1 can be arranged or is arranged via the second partial region 25, for example in particular directly, on a folded edge rim 10b, in particular the flanged edge, of the folded edge 10. The folded edge rim 10b is or forms, for example, the aforementioned second sealing surface. The first sealing surface, for example in the closed position 3, faces downwardly in the vehicle vertical direction 7 and faces to the rear in the vehicle longitudinal direction 11. The second sealing surface, for example in the closed position 3, faces downwardly in the vehicle vertical direction 7 and faces to the front in the vehicle longitudinal direction 11. Thus the sealing surfaces extend, for example, obliquely or perpendicularly to one another.

Preferably, the sealing element 1, in particular the first partial region 24, has at least one fastening surface 26 for fastening the sealing element 1 to the front flap 4, in particular to the first front flap part 8, preferably to the folded edge 10. The fastening surface 26 is configured, for example, as an adhesive surface 27 for fastening the sealing element 1 to the front flap 4 by means of adhesive bonding. Thus the fastening surface 26 is configured, for example, as a support surface, i.e. as a step for an adhesive tape, by means of which the sealing element 1, in particular the first partial region 24 and the front flap 4, for example a further front flap part 8, in particular the folded edge 10 or the first sealing surface, can be adhesively bonded or are adhesively bonded or have been adhesively bonded together.

Preferably, the sealing element 1 has at least one support region 28 via which the sealing element 1 can be supported or is supported, for example upwardly in the vehicle vertical direction 7 and/or to the rear in the vehicle longitudinal direction 11, in particular directly, on a hard component 29 which is arranged on the front flap 4 and which can be denoted as the second hard component 29. This support preferably takes place via at least one rib 30 of the second hard component 29. Preferably, however, a plurality of such ribs 30 are provided. This means that the sealing element 1 can be supported or is supported via the support region 28, for example, directly on the hard component 29 by means of the ribs 30. The rib 30 or the respective rib 30, for example, bears, in particular directly, against the support region 28 and against the first front flap part 8, in particular against the folded edge 10. This bearing takes place, for example, via one and the same surface of the rib 30 or the respective rib 30. Thus, for example, via the support region 28 the sealing element and the folded edge 10 adjoin the second hard component 29 in one and the same direction, in particular directly. For example, the second hard component 29 is arranged, in particular fastened, on the second front flap part 9. The sealing element 1 can be aligned or centered by means of the respective rib 30, whereby the respective rib 30 can also be denoted as the respective alignment rib. For example, accordingly the alignment ribs can be provided on a trimmed edge of an outer skin of the front flap 4, wherein a tolerance relative to the flanged radius is, for example, ±0.7 mm. The second hard component 29 is thus, in particular, a component with bearing ribs in the form of alignment ribs, wherein these alignment ribs can be arranged or are arranged, for example, on a trimmed edge of the flanged edge.

An exemplary assembly sequence is explained hereinafter. For example, in particular firstly, the second hard component 29 is arranged, in particular fastened, on the front flap 4, for example on the second front flap part 9. The hard component 29 is aligned, for example with its ribs 30, against the trimmed edge of the flanged edge and, for example, applied or tightened with screws. For example, in particular subsequently, a cover film is peeled off the aforementioned adhesive tape, whereby the sealing element 1 can be pressed against the front flap 4, in particular in order to bring about the aforementioned adhesive bonding. The peel-off film can be understood to mean, in particular, a liner of the adhesive tape. Residual tolerances can then be compensated, for example, by compressing the sealing element 1. A soft component of a further seal is dispensed with, for example, since this can be replaced by the first hard component 19, for example.

Preferably, the motor vehicle has headlights 18 spaced apart from one another in the vehicle transverse direction 31. This means that the motor vehicle, for example, has the aforementioned headlight 18 and at least one second headlight 18 which is configured, in particular, separately from the headlight 18 and which is spaced apart from the headlight 18 denoted as the first headlight 18, in particular in the vehicle transverse direction 31. For example, it is provided that the sealing element 1 does not extend in the vehicle transverse direction 31 between the headlights 18. This means that a region extending in the vehicle transverse direction 31 between the headlight 18, for example, is free of the sealing element 1. Preferably, the motor vehicle has two such sealing elements 1, wherein the respective sealing element 1 is arranged, in particular, in the region of the respective headlight 18.

Numerical terms such as “first”, “second”, “third”, etc. are provided, in particular, merely for differentiation and do not indicate, in particular, any sequence. In other words, the corresponding numerical terms can be exchanged for one another as desired.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Sealing element
2 Front region
3 Closed position
4 Front flap
5 Front-side receiving space
6 Environment
7 Vehicle vertical direction
8 First front flap part
9 Second front flap part
10 Folded edge
10a Inner face
10b Folded edge rim
11 Vehicle longitudinal direction
12 Front end
13 Receiving region
14 First bearing region
15 Second bearing region
16 Structural element
17 Component
18 Headlight
19 First hard component
20 Predetermined bending point
21 First position
22 Second position
23 Dashed line
24 First partial region
25 Second partial region
26 Fastening surface
27 Adhesive surface
28 Support region
29 Hard component
30 Rib
31 Vehicle transverse direction

What is claimed is:

1. A sealing element for a motor vehicle, comprising:
a sealing element body configure with:
at least one first bearing region via which the sealing element body is arrangeable on a front flap of the motor vehicle, which front flap is pivotable between a closed position and at least one open position; and
at least one second bearing region via which the sealing element body is arrangeable at least indirectly on a structural element of the motor vehicle, which structural element is configured separately from the front flap,
wherein, in the closed position, the front flap is supportable at least indirectly on the structural element via the sealing element body by way of the first and second bearing regions, and
wherein the first bearing region of the sealing element body is configured so as to surround, at least in some areas, a folded edge of the front flap which is arranged at a front end of the front flap in a vehicle longitudinal direction.

2. The sealing element as claimed in claim 1, wherein
the second bearing region is arranged further below the first bearing region in a vehicle vertical direction.

3. The sealing element as claimed in claim 1, wherein
the first bearing region has two partial regions extending obliquely or perpendicularly to one another.

4. The sealing element as claimed in claim 3, wherein
the sealing element body is arranged via a first of the partial regions on the folded edge, on an inner face of the folded edge, and
the sealing element body is arranged via the second of the partial regions on a folded edge rim of the folded edge.

5. The sealing element as claimed in claim 1, wherein
the sealing element body has at least one fastening surface for fastening to the front flap.

6. The sealing element as claimed in claim 5, wherein
the fastening surface is an adhesive surface for fastening the sealing element body to the front flap by adhesive bonding.

7. The sealing element as claimed in claim 1, wherein
the sealing element body is arranged via the second bearing region at least indirectly on a component of a headlight as the structural element.

8. The sealing element as claimed in claim 1, further comprising:
at least one support region of the sealing element body, the sealing element body being able to be supported thereby on a hard component which is arranged on the front flap.

9. The sealing element as claimed in claim 1, wherein
the first and second bearing regions are connected together at least indirectly via a predetermined bending point, and
when pivoting the front flap into the closed position, the first and second bearing regions are able to be pivoted thereon relative to one another by at least indirect action on the sealing element body by the structural element via deformation of the sealing element body.

10. An arrangement of a sealing element of a motor vehicle, comprising:
a front flap on a front region of the motor vehicle;
a structural element of the motor vehicle configured separately from the front flapflaps;
a sealing element body of the sealing element arranged, via a first bearing region of the sealing element body, on the front flap, which front flap is pivotable between a closed position and at least one open position, at least in the closed position of the front flap, and
the sealing element body of the sealing element being arranged, via a second bearing region of the sealing element body, at least in the closed position at least indirectly on the structural element,
wherein, in the closed position, the front flap is supported at least indirectly on the structural element via the sealing element body via the first and second bearing regions, and
wherein the first bearing region surrounds, at least in some regions, a folded edge of the front flap, which folded edge is arranged at a front end of the front flap in a vehicle longitudinal direction.
